(19) United States
(12) Patent Application Publication
(10) Pub. No.: US 2014/0262613 A1
(43) Pub. Date: Sep. 18, 2014

(54) Ladder Corner Roller

(71) Applicant: CUSTOM SERVICE HARDWARE, INC., Cedarburg, WI (US)

(72) Inventor: Franklin D. Rasmussen, WEST BEND, WI (US)

(73) Assignee: CUSTOM SERVICE HARDWARE, INC., Cedarburg, WI (US)

(21) Appl. No.: 14/216,302

(22) Filed: Mar. 17, 2014

Related U.S. Application Data
(60) Provisional application No. 61/791,710, filed on Mar. 15, 2013.

(51) Int. Cl. E06C 7/00

(52) U.S. Cl. CPC E06C 7/00
USPC 182/36

(57) ABSTRACT

A mechanism directed to the art of rolling ladders is provided. A swivel roller capable of being attached to a rolling ladder to enable the rolling ladder to traverse an interior corner. The swivel roller has a mounting bracket with a hinged member and first and second wheels for supporting and moving the rolling ladder along a rail.

### RELATED APPLICATIONS

This application claims the benefit of co-pending U.S. Provisional Patent Application Ser. No. 61/791,710, filed on 15 Mar. 2013, and titled “Ladder Corner Roller.”

### BACKGROUND OF THE INVENTION

Rolling ladders, such as ladders which roll along a fixed rail, are well known to those in the art. Rolling ladders are generally used in shelving situations in which the uppermost shelves are out of reach. Step ladders are not ideal as their A-frame design prohibits the ladder from being placed close enough to the shelf for the user to reach the shelf contents, and if turned sideways, the user is required to rotate the body to reach the shelves, putting strain on the back, hips, and knees. Additionally, extension ladders are not ideal, as they must rest against the shelf, which could cause damage to the shelving or the objects being stored on the shelving. Moreover, placement of the ladder may be inconsistent and unstable. Therefore, rolling ladders provide a stable, easily movable, ladder which provides both aesthetic and functional value.

However, rolling ladders are generally hindered by their inability to travel through corners. Due to the way rolling ladders are attached to a rail, by rollers near the top of each leg, the radius of the rail in a corner must be fairly large to prevent binding of the rollers on the rail. A large rail radius bend in a corner means that the rail will be a fairly large distance away from the shelving, thus reducing the benefits gained by using a rolling ladder as a user will have to extend away from the ladder to reach items stored on the shelves in a corner. Accordingly, the art of rolling ladders could benefit from a rolling ladder capable of traversing smaller radius corners.

### SUMMARY OF THE INVENTION

The present invention relates to a roller assembly for a rolling ladder, more particularly a swivel roller capable of traversing corners. The swivel roller comprising a mounting bracket with a hinged member attached to the rolling ladder and a pair of wheels attached to the hinged member positioned to be on opposite sides of a rail. It is contemplated that the present invention allows the ladder to traverse a rail having a significantly smaller radius corner than other rollers, thereby permitting the ladder to remain closer to the shelving.

One aspect of the invention provides a swivel roller for interfacing a rolling ladder with a rail, the swivel roller having an attachment bracket attached to the ladder, a hinged mounting bracket connected to the attachment bracket, and a wheel attached to the hinged mounting bracket.

The ladder may have length and the hinged mounting bracket may have a pivot axis substantially parallel with the length of the ladder and the wheel may have a rotation axis substantially perpendicular to the hinged mounting bracket pivot axis.

The hinged mounting bracket may be slidably connected to the attachment bracket.

The wheel may have a wheel first end portion, a wheel second end portion opposite the wheel first end portion, and a wheel valley between the wheel first end portion and the wheel second end portion, whereby the wheel first end portion is closer to the hinged mounting bracket member than the wheel second end portion, and wherein the wheel valley has an inwardly curved profile to receive the rail within.

The wheel first end portion may have a wheel first end portion diameter and the wheel second end portion may have a wheel second end portion diameter, wherein the wheel first end portion diameter is larger than the wheel second end portion diameter.

Another aspect of the invention provides a swivel roller for interfacing a rolling ladder having a length to a rail, the swivel roller having an attachment bracket attached to the rolling ladder, a hinged mounting bracket comprising a mating member rotatably affixed to a hinged member, wherein the mating member is slidably attached to the attachment bracket for linear movement of the ladder relative to the hinged mounting bracket, a first wheel having a first wheel axis of rotation, a second wheel having a second wheel axis of rotation, the first wheel and the second wheel attached to the hinged member, wherein the first wheel is next to the second wheel, with the first wheel axis of rotation and the second wheel axis of rotation are substantially perpendicular to the length of the ladder, and whereby the first wheel may be configured to be placed substantially above the rail and the second wheel may be configured to be placed substantially below the rail.

The first wheel may have a first wheel first end portion, a first wheel second end portion opposite the first wheel first end portion, and a first wheel valley between the first wheel first end portion and the first wheel second end portion, and the second wheel may have a second wheel first end portion a second wheel second end portion opposite the second wheel first end portion, and a second wheel valley between the second wheel first end portion and the second wheel second end portion, whereby the first wheel first end portion is closer to the hinged member than the first wheel second end portion, whereby the second wheel first end portion is closer to the hinged member than the second wheel second end portion, wherein the first wheel valley has an inwardly curved profile to receive the rail within, and wherein the second wheel valley has an inwardly curved profile to receive the rail within.

The first wheel first end portion may have a first wheel first end portion diameter, the first wheel second end portion may have a first wheel second end portion diameter, the second wheel first end portion may have a second wheel first end portion diameter, and the second wheel second end portion may have a second wheel second end portion diameter, and whereby the first end portion diameter of at least one of the first wheel first end portion and second wheel first end portion is larger than the respective second end portion diameter of the first wheel second end portion or second wheel second end portion.

### BRIEF DESCRIPTION OF THE DRAWINGS

FIG. 1 is a perspective view of a rolling ladder incorporating swivel rollers according to the present invention.

FIG. 2 is a perspective view of one of the swivel rollers of FIG. 1.

FIG. 3 is a side view of the swivel roller of FIG. 1.

FIG. 4 is a top view of the swivel roller of FIG. 1.

FIGS. 5A-7B illustrate a rolling ladder incorporating the swivel rollers in use on a rail.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention. Further, it should be known that any reference to a top or a bottom in this disclosure is for illustrative purposes only and should not be construed as limiting the spatial orientation of the present invention.

FIG. 1 illustrates rollers 10A and 10B according to the present invention. Swivel rollers 10A and 10B are substantially identical in form but individually designated for ease of describing the swivel rollers 10A and 10B in use. However, part number “10” will be used when describing the components of an individual swivel roller 10. As shown here, the rollers 10A and 10B are attached to a rolling ladder 72 and installed on a rail 74 attached to a shelving system 76. In addition to the rollers 10A and 10B positioned at the top of the ladder, bottom rollers 78 may be attached to the bottom of the ladder to assist in rolling the ladder 72.

FIGS. 2-4 show an enlarged view of a swivel roller 10 attached to the ladder 72 and positioned on the rail 74. The roller 10 comprises an attachment bracket 20 and a mounting bracket 30.

With particular attention to FIG. 4, the attachment bracket 20 may be seen. The attachment bracket 20 comprises a first side member 22 adjacent to an interface side member 24, and a second side member 26 also adjacent to the interface side member 24 and opposite the first side member 22. The interface side member 24 preferably extends past the first side member 22 and the second side member 26 thereby providing extensions 28.

The mounting bracket 30 comprises a mating member 32, a hinged member 40 rotatably attached to the mating member 32, and a first wheel 50 and a second wheel 60 both attached to the hinged member 40.

The mating member 32 shown here comprises a receiving portion 34 and mating member knuckles 36 having mating member knuckle holes 38 (see FIG. 3) located longitudinally therethrough. The receiving portion 34 is configured to receive the extensions 28 of the attachment bracket 20 in a sliding relationship.

The hinged member 40 comprises hinge member knuckles 42 and a face 46 opposite the hinge member knuckles 42. The face 46 provides a place to attach the first wheel 50 and the second wheel 60 with wheel pins or screws 68. Additionally, the hinge member knuckles 42 have hinge member knuckle holes 44 located longitudinally therethrough (see FIG. 3). The hinge member knuckles 42 interface with the mating member knuckles 36 and are joined by a hinge pin or screws 70 placed through the respective knuckle holes 38 and 44, thereby allowing the hinged member 40 to pivot relative to the mating member 32 in the directions illustrated by arrow A in FIG. 4. Thus, the hinged member 40 preferably has a rotational axis substantially parallel with the length of the ladder 72 and substantially perpendicular with rotational axis of the first and second wheels 50 and 60.

The first wheel 50 comprises a first wheel first end portion 52, a first wheel valley 54, and a first wheel second end portion 56. The first wheel valley 54 preferably has an inwardly curved profile substantially similar to the curved circumferential surface profile of the rail 74. The first wheel first end portion 52 has a larger diameter than the diameter of the first wheel second end portion 56, and, as shown here, the first wheel first end portion 52 is closest to the hinged member face 46.

The second wheel 60 comprises a second wheel first end portion 62, a second wheel valley 64, and a second wheel second end portion 66. The second wheel valley 64 preferably has an inwardly curved profile substantially similar to the curved circumferential surface profile of the rail 74. The second wheel first end portion 62 has a larger diameter than diameter of the second wheel second end portion 66, and, as shown here, the second wheel first end portion 62 is positioned closest to the hinged member face 46.

The substantially similar profiles of the rail 74 and the first and second wheel valleys 54 and 64 encourages consistent alignment of the first and second wheels 50 and 60 on the rail 74 and discourages the hinged member 40 from rotating relative to the mating member 32 at any time other than when traversing a corner (shown in FIGS. 6A-6B).

The substantially circumferential interface between the roller 10 and the rail 74 permits the ladder 72 to rotate radially about the rail 74. This capability in combination with the slidable interface between the mounting bracket 30 and the attachment bracket 20 permits the ladder 72 to be placed in a position in which the ladder 72 is substantially vertical and parallel to the shelving system 76, yet also permits the ladder 72 to be rotated away from the shelving system 76 to provide a more user-friendly climbing angle. The ladder 72 and attachment bracket 20 may also be completely separated from the mounting bracket 30.

FIGS. 5A-7B demonstrate how the rollers 10A and 10B move along the rail 74 and the interior corner IC in the direction of arrow B. With attention to FIGS. 5A and 5B, the ladder 72 is shown moving along rail 74 towards the interior corner IC. Roller 10A is forward with respect to roller 10B in direction A and both rollers 10A and 10B are parallel

As the ladder 72 moves along the rail 74 through the interior corner IC as shown in FIGS. 6A and 6B, the rollers 10A and 10B rotate with respect to the ladder 72 to permit the ladder to traverse the interior corner IC.

FIGS. 7A and 7B illustrate the ladder 72 exiting the interior curve IC. The swivel rollers 10A and 10B return to their parallel orientation.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

I claim:

1. A swivel roller for interfacing a rolling ladder with a rail, the swivel roller comprising:
an attachment bracket attached to the ladder;
a hinged mounting bracket connected to the attachment bracket; and
a wheel attached to the hinged mounting bracket.

2. The swivel roller according to claim 1 wherein the ladder has a length and the hinged mounting bracket has a pivot axis substantially parallel with the length of the ladder and the wheel has a rotation axis substantially perpendicular to the hinged mounting bracket pivot axis.

3. The swivel roller of claim 1 wherein the hinged mounting bracket is slidably connected to the attachment bracket.

4. The swivel roller of claim 1 wherein the wheel comprises a wheel first end portion, a wheel second end portion opposite the wheel first end portion, and a wheel valley between the wheel first end portion and the wheel second end portion;
whereby the wheel first end portion is closer to the hinged mounting bracket member than the wheel second end portion; and
wherein the wheel valley has an inwardly curved profile to receive the rail within.

5. The wheel of claim 4 wherein the wheel first end portion has a wheel first end portion diameter and the wheel second end portion has a wheel second end portion diameter;
wherein the wheel first end portion diameter is larger than the wheel second end portion diameter.

6. A swivel roller for interfacing a rolling ladder having a length to a rail, the swivel roller comprising:
an attachment bracket attached to the rolling ladder;
a hinged mounting bracket comprising a mating member rotatably affixed to a hinged member, wherein the mating member is slidably attached to the attachment bracket for linear movement of the ladder relative to the hinged mounting bracket;
a first wheel having a first wheel axis of rotation;
a second wheel having a second wheel axis of rotation;
the first wheel and the second wheel attached to the hinged member, wherein the first wheel is next to the second wheel, with the first wheel axis of rotation and the second wheel axis of rotation are substantially perpendicular to the length of the ladder; and
whereby the first wheel is configured to be placed substantially above the rail and the second wheel is configured to be placed substantially below the rail.

7. The swivel roller according to claim 6 wherein the first wheel comprises a first wheel first end portion, a first wheel second end portion opposite the first wheel first end portion, and a first wheel valley between the first wheel first end portion and the first wheel second end portion, and the second wheel comprises a second wheel first end portion a second wheel second end portion opposite the second wheel first end portion, and a second wheel valley between the second wheel first end portion and the second wheel second end portion;
whereby the first wheel first end portion is closer to the hinged member than the first wheel second end portion;
whereby the second wheel first end portion is closer to the hinged member than the second wheel second end portion;
wherein the first wheel valley has an inwardly curved profile to receive the rail within; and
wherein the second wheel valley has an inwardly curved profile to receive the rail within.

8. The swivel roller of claim 7 wherein the first wheel first end portion has a first wheel first end portion diameter, the first wheel second end portion has a first wheel second end portion diameter, the second wheel first end portion has a second wheel first end portion diameter, and the second wheel second end portion has a second wheel second end portion diameter; and
whereby the first end portion diameter of at least one of the first wheel first end portion and second wheel first end portion is larger than the respective second end portion diameter of the first wheel second end portion or second wheel second end portion.
